(19) United States
(12) Patent Application Publication
(10) Pub. No.: US 2007/0257836 A1
(43) Pub. Date: Nov. 8, 2007

(54) Site survey tracking

(76) Inventor: Clint Chaplin, San Jose, CA (US)

Correspondence Address: THORNE & HALAJIAN;APPLIED TECHNOLOGY CENTER, 111 WEST MAIN STREET, BAY SHORE, NY, 11706, US

(21) Appl. No.: 11/429,501

(22) Filed: May 5, 2006

(51) Int. Cl. G01S 5/14

(52) U.S. Cl. 342/357.08; 342/357.17

(57) ABSTRACT

A site survey device including a location sensor and a processor coupled to the location sensor. The processor acquires location information from the location sensor and determines reception data relating to a signal received from a wireless device to identify a location wherein the reception data is determined. The location sensor may include an electronic compass to produce electrical signals corresponding to a heading of a surveyor and an inertial sensor to produce electrical signals corresponding to a magnitude of a change in location. The location information may be determined as a change in location. In operation, a plurality of location information may be acquired together with corresponding reception data from a wireless infrastructure. The device may indicate each of the plurality of location information and corresponding reception data on an electronic indication of a site map.

### FIELD OF THE INVENTION

The present system relates to site survey tracking and a system for determining a location of a surveyor during surveying.

### BACKGROUND OF THE INVENTION

As part of setting up a wireless infrastructure, an initial site survey may be performed to determine coverage requirements at a given location, followed by a subsequent survey after initial setup of wireless access points to ensure proper wireless access throughout a given location. Site surveys are typically performed by a surveyor walking though the given location, taking periodic measurements of access points reception signal strength, hereinafter, reception data, and indicating the reception data on a site map to correlate the reception data with a given location.

A problem exists with site surveys in that it is problematic to determine a precise location where the reception data is collected. Oftentimes, the surveyor is provided with a paper or electronic site map, such as a floor plan, and is required to indicate where on the floor plan a given set of reception data is collected. However, reception data can vary greatly within a given location even with only a relatively small change in location and the surveyor is not provided with any means of accurately determining location. Environmental conditions such as metal building portions, desks, and other wireless devices may alter reception data collected dramatically over relatively small variations in location. Yet it is imperative that accurate location data be acquired to assist in proper setup of the wireless infrastructure.

Global positioning systems (GPS) may assist in identifying an approximate position in an open environment yet typically are not available in a closed environment, like inside a building. In addition, GPS location data has an inherent inaccuracy of as much as several meters that renders this type of location data of little or no assistance in an attempt at an accurate site survey. Other systems exist that enable location identification through use of instrumented, marked, or mapped infrastructure but require enormous resources and expenses to setup which renders these solutions too expensive and cumbersome to provide a real-world useable solution.

It is an object of the present system to overcome disadvantages and/or make improvements in the prior art.

### SUMMARY OF THE INVENTION

A site survey device to assist a surveyor during a site survey of a wireless infrastructure, the device including a location sensor and a processor operationally coupled to the location sensor. The processor acquires location information from the location sensor and determines reception data relating to a signal received from a wireless device, and thereby identifies a location wherein the reception data is determined. The location sensor may include an electronic compass to produce electrical signals corresponding to a heading of the surveyor and an inertial sensor configured to produce electrical signals corresponding to a magnitude of a change in location. In this embodiment, the location information is determined as a change in location. In one embodiment, the location sensor includes a GPS for producing calibration data to calibrate the electronic compass to true-north. In operation, a plurality of location information may be acquired together with corresponding reception data. The device may indicate each of the plurality of location information and corresponding reception data on an electronic indication of a site map.

The location sensor may acquire correction data for correcting determined location information. The location sensor may include at least one of a camera, a ranging sensor, and a GPS for acquiring the correction data. Where the location sensor includes the camera, the camera may operate as a portion of a head-mounted imaging system to detect an object at the survey site that has a known position.

### BRIEF DESCRIPTION OF THE DRAWINGS

The following are descriptions of illustrative embodiments that when taken in conjunction with the following drawings will demonstrate the above noted features and advantages, as well as further ones. In the following description, for purposes of explanation rather than limitation, specific details are set forth such as architecture, interfaces, techniques, etc., for illustration. However, it will be apparent to those of ordinary skill in the art that other embodiments that depart from these details would still be understood to be within the scope of the appended claims. Moreover, for the purpose of clarity, detailed descriptions of well-known devices, circuits, and methods are omitted so as not to obscure the description of the present system.

It should be expressly understood that the drawings are included for illustrative purposes and do not represent the scope of the present system in which:

FIG. 1 shows an illustrative system in accordance with an embodiment of the present system; and

FIG. 2 shows a flow diagram illustrating an operation in accordance with an embodiment of the present system.

### DETAILED DESCRIPTION OF THE INVENTION

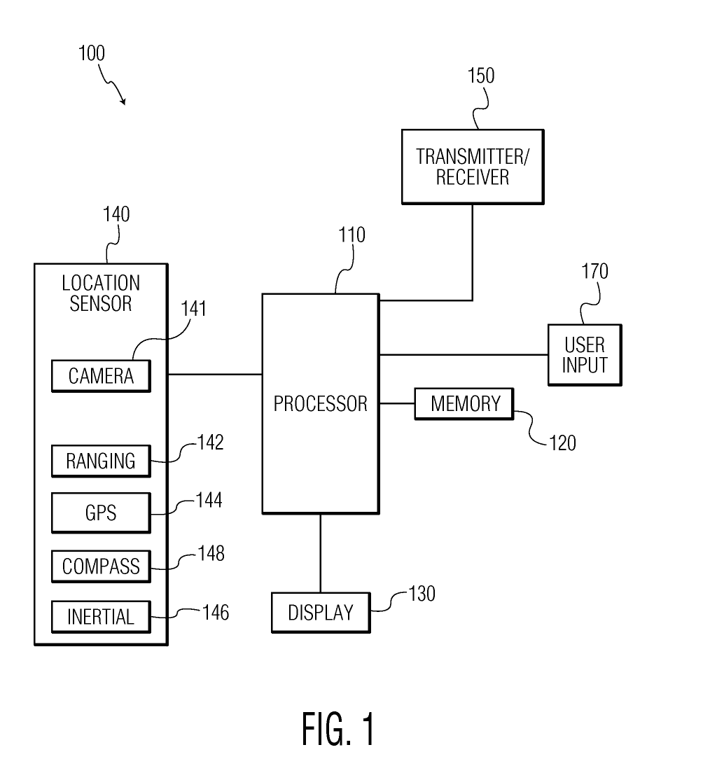

FIG. 1 shows an illustrative system 100 in accordance with an embodiment of the present system. The system 100 includes a processor 110 operationally coupled to computer readable medium illustrated as a memory 120, a user input 170, a display device 130, a location sensor 140, and a transmitter/receiver 150. As is known in the art, the methods and apparatus discussed herein may be distributed as an article of manufacture that itself comprises the memory 120 having computer-readable code embodied thereon. The computer-readable code is operable, in conjunction with the processor 110, to carry out all or some of the acts to perform the methods or create the apparatus discussed herein. The memory 120 may be a recordable medium (e.g., floppy disks, hard drives, DVD, solid state memory, memory cards, etc.) or may be a transmission medium (e.g., a network comprising fiber-optics, the world-wide web, cables, or a wireless channel using time-division multiple access, code-division multiple access, or other radio-frequency channel). Any medium known or developed that can store and/or provide information suitable for use with the system 100 may be used. The computer-readable code is any mechanism for allowing the processor 110 to read and write instructions and data, such as magnetic variations on a magnetic medium or height/light deflecting variations on the surface of a compact disk.

The memory 120 may be long-term, short-term, or a combination of long and short term memories. The memory 120 configures the processor 110 to implement the methods, acts, and functions disclosed herein. The memory 120 may be distributed or local and the processor 110 may be distributed or singular. For example, the location sensor 140, transmitter/receiver 150, etc. may contain a portion of the processor 110 and/or the memory 120 for performing some of the acts described herein and others. The memory 120 may be implemented as electrical, magnetic or optical memory, or any combination of these or other types of storage devices. Moreover, the term “memory” should be construed broadly enough to encompass any information able to be read from or written to an address in an addressable space accessible by the processor 110. With this definition, information on a network is still within the memory 120 since the processor 110 may retrieve/write the information from/to the network. It should also be noted that some or all of operations described herein may be incorporated into an application-specific or general-use integrated circuit including the operation of the processor 110 and the memory 120.

Further, the processor 110 may be a dedicated processor for performing in accordance with the present system or may be a general-purpose processor wherein only one of many functions operates for performing in accordance with the present system. The processor 110 may operate utilizing a program portion, multiple program segments, or may be a hardware device utilizing a dedicated or multi-purpose integrated circuit.

For example, the memory 120 may contain program portions for configuring the processor to display a user interface on the display 130 including an electronic pictorial representation, such as a map, of a survey site thereby facilitating operation in accordance with the present system. While the map is optional since the processor 110 may operate without providing feedback to the surveyor, the map may assist the surveyor in determining when to initiate acquisition of reception data as well as a time to acquire location correction data as described further hereinafter. However, in some embodiments in accordance with the present system, the processor 110 may autonomously determine the timing of acquiring reception data and correction data.

The processor 110 is operationally coupled to the user input 170, such as a joystick type input with selection actuation inputs (e.g., buttons) or other inputs of the like, to facilitate operation within the user interface provided on the display 130. The location sensor may include one or more location sensor elements, such as a camera 141, a ranging sensor 142, such as sonar, high frequency (HF), infrared, etc., a global positioning system (GPS) 144, an electronic compass system 148, an inertial guidance system 146, and/or other systems of the like that facilitate an autonomous determination of a surveyors location during the course of a survey. While each of the sensor elements are shown within the location sensor 140 shown in FIG. 1, this is merely intended as a functional limitation in that any one or more of the sensor elements may operate synergistically yet be provided in different physical locations and/or enclosures. However, as would be readily apparent to a person of ordinary skill in the art, this clearly does not introduce any physical limitations on an actual placement of the sensor elements. For example, the inertial sensor 146 may be positioned on a foot of the surveyor, for example as a foot mounted pedometer, while the camera 141 may be positioned on a head of the surveyor, such as a head-mounted camera or imaging system.

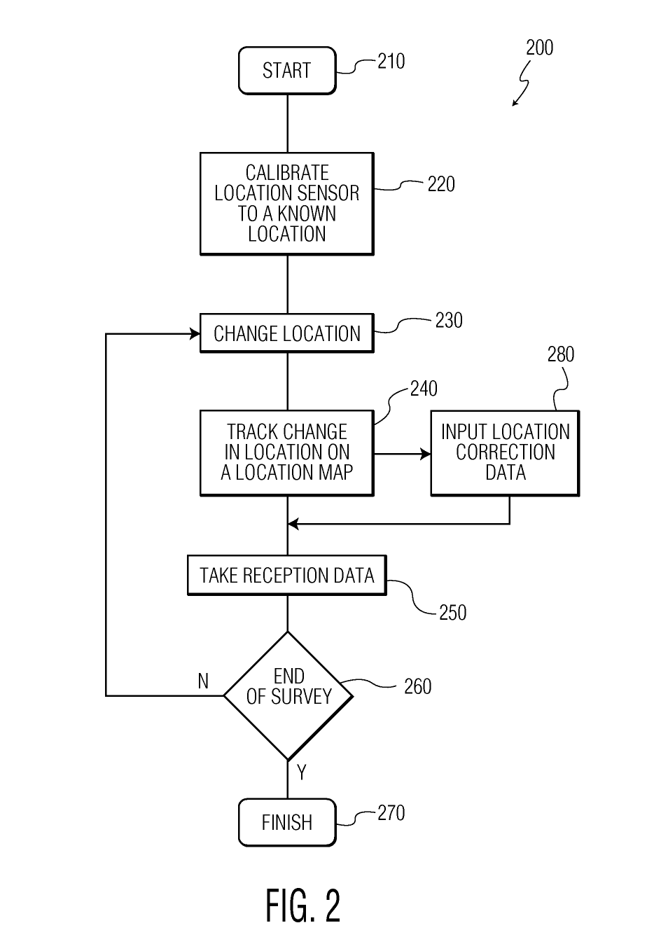

Further operation of the present system will be presented in conjunction with FIG. 2 which shows a flow diagram 200 illustrating an operation in accordance with an embodiment of the present system. In accordance with the present system, a starting act, such as turning on the system 100, is performed during act 210 to initiate a site survey. During act 220, the location sensor 140 is calibrated to a known location, or in some embodiments, acquires a present location within or in proximity to the survey site. For a location sensor 140 including an inertial guidance system, such as a foot mounted inertial guidance system described in “Pedestrian Tracking with Shoe-Mounted Inertial Sensors, by Eric Foxlin, IEEE Publication, Moving Mixed Reality into the Real World, November/December 2005, incorporated herein as if set out in entirety, a present location may be provided by the surveyor starting at a known starting location. In this embodiment, the starting location may be determined by any suitable act or acts. For example, an infrastructure may be initiated within a given location for determining a starting location with precision. For example, two or more GPS receivers may be setup to each determine an approximate position of the receivers as is known in the GPS art. After the approximate position of the receivers is determined, position information between the receivers may be determined and utilized to correct for uncertainty in the GPS determined locations. This corrected location information may be utilized for calibrating a starting location.

Other simpler systems may be employed such as starting in a readily determinable position within a site, such as a corner of a room, doorway, wall, or other positions of the like. In a location sensor that includes two or more location sensor elements, the elements may work together to determine a starting location separately or together with data available from the electronic map. For example, the camera 141, such as a head-mounted imaging system, and the ranging sensor 142 may operate together to identify a location. The camera 141 may provide orientation at the starting location while the ranging sensor 142 may provide an accurate measurement of a distance from objects identified through use of the camera 141 and for example, a computer vision system provided by the processor 110.

In another embodiment, a starting position may be selected to ensure that the GPS 144 is provided with adequate GPS signal reception for a duration of movement of the surveyor, such as within 10-400 meters of movement, to calibrate the compass 148 to true-north, as opposed to magnetic north which is susceptible to fluctuations due to environmental conditions. Thereafter, the compass 148 together with the inertial sensor 146, may identify both a magnitude and direction of movement, including a drift direction. Other systems for determining a starting location would readily occur to a person of ordinary skill in the art and are intended to be encompassed by the present system.

In any event of how a starting location is acquired, thereafter during act 230 the surveyor changes location in a measured amount as determined by the location sensor 140 to produce a change in location and thereby, produce a measured location (e.g., a location determined by the location sensor 140 with the processor 110). The change in location is tracked on a location map during act 240, which tracking may be provided to the surveyor through the user interface on the display 130. For a location sensor 140 including an inertial sensor 146, placement of the inertial sensor 146 on a foot of the surveyor may enable a more accurate determination of a magnitude of motion and thereby a more accurate determination of the measured location since the inertial sensor 146 is able to more accurately determine the magnitude of motion when provided with acceleration, such as provided by a typical stride, as opposed to a constant motion, such as provided by the motion of a torso of the surveyor while walking within the survey site.

After some change in position, the processor 110, through use of the transmitter/receiver 150, may acquire reception data during act 250 to determine a quality of wireless coverage in the now current position. Reception data may be acquired periodically (e.g., act 260 followed by act 230 as shown) or otherwise by the processor 110, such as determined by time periods, magnitude of change in location, as initiated by the surveyor through use of the user input 170, etc. During act 260, it is determined whether the site survey is completed. When the site survey is completed, the site survey finishes during act 270 when for example, reception data may be stored or correlated to identify whether placement of a wireless infrastructure is sufficient or may be modified as desired.

During some period of time, it may become desirable to correct for any error in the measured location as compared to an actual location. Illustratively this is shown in FIG. 2 during act 280 following act 240. However, as would readily be apparent to a person of ordinary skill in the art, correction in the measured location may occur at any time even simultaneously during other acts for a processor 110 that has an ability to multitask or quasi-multitask like in a carouselling task enabled processor. In any event of how the processor 110 manages processes, the correction in the measured location may be initiated in numerous ways including ways similar to how taking of reception data is initiated. For example, the correction in the measured location may be initiated periodically by the system 100 every regular or irregular time period. In this embodiment, the correction in the measured location may be initiated once per second, once per measurement of reception data (e.g., act 280 always preceding or following act 250), and/or during some combination thereof. Act 280 may also be initiated by the surveyor operating through use of the user input 170 within the user interface provided by the processor 110 for example, on the display 130.

In addition or in place of one or more of the above acts for initiating the correction in the measured location, the location sensor 140 may independently determine to make a correction in the measured location. For example, for an embodiment wherein the location sensor includes a camera 141, the processor 110 may analyze images acquired by the camera 141 and compare features identifiable in the acquired images to features identified in the electronic map. For example, the processor 110 may identify a doorway that the surveyor is passing through at a given time and verify that the present measured location corresponds to the doorway. In a case wherein the present measured location does not correspond to the doorway, the processor 110 may correct the measured location to correspond to the identified location or merely use this “correction” as a way of determining the measured location or a portion thereof.

Further, the processor 110 may retrace measured locations and introduce a correction factor into one or more of the previously measured locations. In this way, the processor 110 may account for the correction in the measured location, for example stepwise (e.g., spread over all previous measured locations) as opposed to introducing all the correction only into the measured location at the time that the correction data is acquired. For example, for a correction factor in the measured location that requires a one foot, one degree, etc. correction, the processor 110 may, though need not, divide the required correction into a number of equal parts representing the number of previous measured locations since a last correction, and introduce the correction equally into each of the previous measured locations. In other embodiments, the location sensor 140 and/or the processor 110 may determine that one or more particular measured locations are likely candidates for an introduction of an error in the measured location and thereby may introduce the correction(s) in the measured location(s) only into those measured locations. In fact, in this or other embodiments, the determination that an error in the measured location is introduced, such as by an erratic sudden change in position initiated by, for example, the surveyor stumbling, may initiate the correction in the measured location act, if correction data is available, or the particular measured location may be identified by the processor 110 for later correction when data for the correction in the measured location is available.

However, as is readily apparent, an error in the measured location initiated by any one element (e.g., camera 141, ranging sensor 142, etc.) of the location sensor 140 is likely inherent in that element, yet with an addition of one or more additional elements to the location sensor 140, each element may be utilized to produce a correction or additional component of the measured location. For example, for a location sensor 140 that includes the compass 148 and the inertial sensor 146, the compass 148 typically provides heading data while the inertial sensors may provide a magnitude of change in location. In this embodiment of the location sensor 140, each of the elements provides a component of the measured location. In a further embodiment wherein the inertial sensor 146 has portions that detect a yaw axis of motion, this detected yaw may be utilized to correct heading data provided by the compass 148. A further correction may be introducible though a presence of more elements into the location sensor 140, such as the GPS 144, ranging sensor 142, camera 141, etc. A further correction in the measured location may be introduced by the surveyor returning to the known location where the survey began or passing through that known location or another that is known.

Of course, it is to be appreciated that in accordance with the present system, any one of the above, elements, embodiments and/or processes may be combined with one or more other elements, embodiments and/or processes. For example, several interactions of the location sensor 140 elements (e.g., camera 141, ranging sensor 142, etc.) are described, yet a potentially larger number of interactions would readily occur to a person of ordinary skill in the art. These and other variations should be understood to be within the scope of the presented claims. Accordingly, the present system provides a real-world useable solution without the requirement for a large initial setup or outlay of time and/or resources in preparation for the survey. As should be clear from the discussion herein, the present system overcomes disadvantages and/or makes improvements over other systems. Further, the present system provides a surveyor an improved way of performing a site survey without the requirement of a large initial setup or outlay of time and/or resources in preparation for the survey.

Finally, the above-discussion is intended to be merely illustrative of the present system and should not be construed as limiting the appended claims to any particular embodiment or group of embodiments. Thus, while the present system has been described with reference to exemplary embodiments, it should also be appreciated that numerous modifications and alternative embodiments may be devised by those having ordinary skill in the art without departing from the broader and intended spirit and scope of the present system as set forth in the claims that follow. In addition, the section headings included herein are intended to facilitate a review but are not intended to limit the scope of the present system. Accordingly, the specification and drawings are to be regarded in an illustrative manner and are not intended to limit the scope of the appended claims.

In interpreting the appended claims, it should be understood that:

a) the word “comprising” does not exclude the presence of other elements or acts than those listed in a given claim;

b) the word “a” or “an” preceding an element does not exclude the presence of a plurality of such elements;

c) any reference signs in the claims do not limit their scope;

d) several “means” may be represented by the same item or hardware or software implemented structure or function;

e) any of the disclosed elements may be comprised of hardware portions (e.g., including discrete and integrated electronic circuitry), software portions (e.g., computer programming), and any combination thereof;

f) hardware portions may be comprised of one or both of analog and digital portions;

g) any of the disclosed devices or portions thereof may be combined together or separated into further portions unless specifically stated otherwise; and

h) no specific sequence of acts or steps is intended to be required unless specifically indicated.

The claimed invention is:

1. A site survey device configured to assist a surveyor during a site survey of a wireless infrastructure, the device comprising:
a location sensor;
and a processor operationally coupled to the location sensor, wherein the processor is configured to acquire location information from the location sensor, is configured to determine reception data relating to a signal received from a wireless device, and thereby identify a location wherein the reception data is determined.

2. The device of claim 1, wherein the location sensor comprises:
an electronic compass configured to produce electrical signals corresponding to a heading of the surveyor; and
an inertial sensor configured to produce electrical signals corresponding to a magnitude of a change in location, wherein the location information is a change in location from a first location to the location where the location information is acquired as determined by the electronic compass and the inertial sensor.

3. The device of claim 2, wherein the location sensor comprises a GPS configured to produce calibration data to calibrate the electronic compass to true-north.

4. The device of claim 1, wherein the location information is one of a plurality of location information, wherein the location sensor is configured to determine each of the plurality of location information and the processor is configured to determine reception data relating to each of the plurality of location information and indicate each of the plurality of location information and corresponding reception data on an electronic indication of a site map.

5. The device of claim 1, wherein the location sensor is configured to acquire correction data and wherein the processor is configured to receive the correcting data for correcting determined location information.

6. The device of claim 4, wherein the location sensor comprises at least one of a camera, a ranging sensor, and a GPS for acquiring the correction data.

7. The device of claim 4, wherein the location sensor comprises the camera which operates as a portion of a head-mounted imaging system configured to detect an object at the survey site that has a known position.

8. A method of performing a site survey of a wireless infrastructure, the method comprising the acts of:
acquiring location information from an electronic location sensor;
determining reception data related to a quality of a received signal from the wireless infrastructure at the location where the location information is acquired.

9. The method of claim 8, wherein acquiring location information comprises the acts of:
receiving heading data corresponding to a heading of a surveyor from a first location to the location wherein the location information is acquired; and
determining inertial data corresponding to a magnitude of a change in location from the first location to the location wherein the location information is acquired.

10. The method of claim 9, the method comprising the act of calibrating the heading data to true-north.

11. The method of claim 8, comprising the acts of:
acquiring a plurality of location information as a change in location from a previous location; and
determining a corresponding plurality of reception data.

12. The method of claim 8, wherein the location information is a change in location from a first location to the location where the location information is acquired, the method comprising the acts of:
acquiring electronic correction data; and
correcting the location information.

13. The method of claim 12, wherein acquiring the correction data comprises the acts of:
identifying a known position; and
determining the location where the location information is acquired from the known position.

14. An application embodied on a computer readable medium configured to aid in a site survey of a wireless infrastructure, the application comprising:
a portion configured to acquire location information from an electronic location sensor;
a portion configured to determine reception data related to a quality of a received signal from the wireless infrastructure at the location where the location information is acquired.

15. The application of claim 14, wherein the portion configured to acquire location information is configured to:
receive heading data corresponding to a heading of a surveyor from a first location to the location wherein the location information is acquired; and
determine inertial data corresponding to a magnitude of a change in location from the first location to the location wherein the location information is acquired.

16. The application of claim 14, comprising a portion configured to correct the location information.

17. A site survey device to assist a surveyor during a site survey of a wireless infrastructure, the device comprising:
a means for acquiring location information from an electronic location sensor;
a means for determining reception data related to a quality of a received signal from the wireless infrastructure at the location where the location information is acquired.

18. The device of claim 17, wherein the means for acquiring location information comprises:
a means for receiving heading data corresponding to a heading of a surveyor from a first location to the location wherein the location information is acquired; and
a means for determining inertial data corresponding to a magnitude of a change in location from the first location to the location wherein the location information is acquired.

19. The device of claim 18, comprising a means for calibrating the heading data to true-north.

20. The device of claim 17, comprising:
a means for acquiring electronic correction data; and
a means for correcting the location information.
